(19) United States
(12) Patent Application Publication
(10) Pub. No.: US 2019/0256117 A1
(43) Pub. Date: Aug. 22, 2019

(54) TROLLEY

(71) Applicant: My Trollee Pty Limited, Merewether (AU)

(72) Inventor: Vic PETROVICH, Little Bay (AU)

(73) Assignee: My Trollee Pty Limited, Merewether (AU)

(21) Appl. No.: 16/111,116

(22) Filed: Aug. 23, 2018

Related U.S. Application Data
(63) Continuation of application No. 15/533,843, filed on Jun. 7, 2017, now abandoned.

(30) Foreign Application Priority Data
Jul. 8, 2015 (AU) 2015902690

(51) Int. Cl. B62B 3/02; B62B 3/10

(52) U.S. Cl. CPC B62B 3/027; B62B 3/106; B62B 2202/26; B62B 2202/12; B62B 2205/06

(57) ABSTRACT

A foldable trolley having an elongate frame defining a frame axis XX and having a first end, a second end and sides extending therebetween. An elongate arm defining an arm axis YY. The arm pivotally attachable to the frame and adapted in use to move from a stored position, where the arm axis is substantially parallel to the frame axis, and a use position, where the arm axis is substantially perpendicular to the frame axis. A support member having a first end, a second end and sides extending therebetween. The support member pivotally attachable to the frame and adapted in use to move from a stored position, where the member is substantially parallel to the frame axis and a use position, where the support member is locatable at an acute angle to the frame axis. The support member adapted in use to hold bags in the use position.

### CROSS-REFERENCE TO RELATED APPLICATIONS

This application is a continuation of U.S. application Ser. No. 15/533,843, filed Jun. 7, 2017, currently pending, which is a 371 U.S. national phase of International Application No. PCT/AU2016/000229 filed on Jun. 29, 2016, each of which claims priority to AU Provisional Patent Application No. 2015902690 filed on Jul. 8, 2015. The disclosures of each of these applications are incorporated in their entirety by reference herein.

### FIELD OF THE INVENTION

The present invention relates to a trolley and in particular to a foldable trolley for carrying shopping bags or the like.

### BACKGROUND OF THE INVENTION

Trolleys have been used for many years to move goods from one place to another. Trolleys come in a variety of shapes and sizes having one wheel to many wheels and having a number of attachments to help carry items. Trolleys also come in fixed forms or folded forms and can be manufactured of various materials such as plastic, metals or the like.

In recent years there has been considerable criticism of retail outlets selling products using plastic bags. This has led to the selling of hessian bags or “green” bags. However, such bags tend to be heavier in weight than plastic bags and more expensive to manufacture. However, as they are sturdier they can carry more items per bag. Accordingly, the consumer resultantly ends up carrying more weight per shopping bag which has caused various physical issues such as neck and back problems.

Supermarkets try to alleviate this issue by providing shopping trolleys. However, such shopping trolleys are difficult to manoeuvre, expensive to manufacture, create a large capital expense, are expensive to maintain and often are taken away from the retail outlet causing the retail outlet considerable cost in finding and returning those trolleys. Further, such shopping trolleys can cause injuries and cause significant liabilities if a shopper is injured by one at the retail outlet.

Accordingly, there is a need for a lightweight, manoeuvrable and cheap shopping trolley that is owned by the consumer (rather than the retail outlet) which the consumer can bring to the retail outlet. The trolley should be able to easily hold or carry green bags or the like. This would remove the retail outlet from significant expenses and liability.

### OBJECT OF THE INVENTION

It is an object of the present invention to substantially overcome or at least ameliorate one or more of the disadvantages of the prior art, or to at least provide a useful alternative.

### SUMMARY OF INVENTION

There is disclosed herein a foldable trolley, said trolley having:

an elongate frame defining a frame axis and having a first end, a second end and sides extending therebetween;

an elongate arm defining an arm axis, said arm pivotally attachable to said frame and adapted in use to move from a stored position, where said arm axis is substantially parallel to said frame axis, and a use position, where said arm axis is substantially perpendicular to said frame axis; and

a support member having a first end, a second end and sides extending therebetween, said support member pivotally attachable to said frame and adapted in use to move from a stored position, where said member is substantially parallel to said frame axis and a use position, where said support member is locatable at an acute angle to said frame axis;

said support member adapted in use to hold bags in said use position.

Preferably, said trolley includes two arms, said arms being connected at one end to said sides of said frame and at said other end to one or more wheels to permit said trolley to move along a surface.

Preferably, said two arms are connected by a connecting member.

Preferably, said frame includes at least one wheel at one said end.

Preferably, said frame is generally a rectangular ring shape, the ends and sides defining a space therebetween.

Preferably, said support members are locatable and pivotable within said space.

Preferably, said support members are a rectangular ring shape and define an aperture therebetween.

Preferably, in use said bags are locatable within said aperture.

Preferably, an end of said frame includes a handle.

Preferably, an end of said frame includes a foot platform.

Preferably, said frame includes two or more support members adapted to hold bags in use within said space.

Preferably, said support members are positionable between said sides of said frame.

### BRIEF DESCRIPTION OF DRAWINGS

A preferred embodiment of the invention will now be described, by way of example only, with reference to the accompanying drawings, wherein:

FIG. 1 shows an embodiment of the present invention in a stored position;

FIGS. 2a and 2b show an embodiment of the present invention in a use position in two directions;

FIG. 3 shows an embodiment of the present invention from a top view;

FIG. 4 shows an embodiment of the present invention from a side view; and

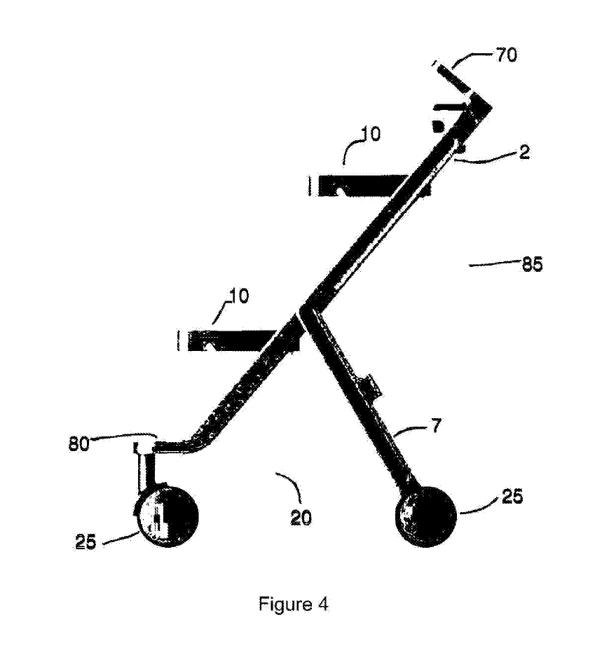

FIGS. 5a and 5b show an alternate embodiment of the present invention in a use position in two directions.

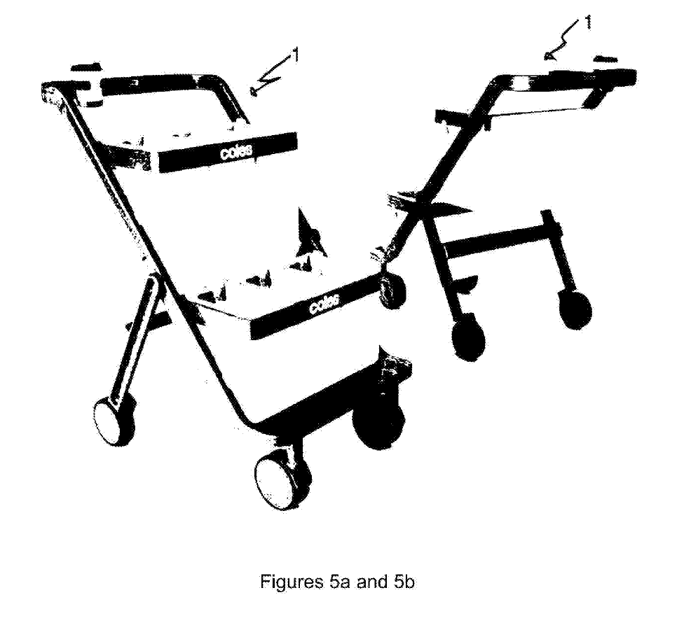

### DESCRIPTION OF EMBODIMENTS

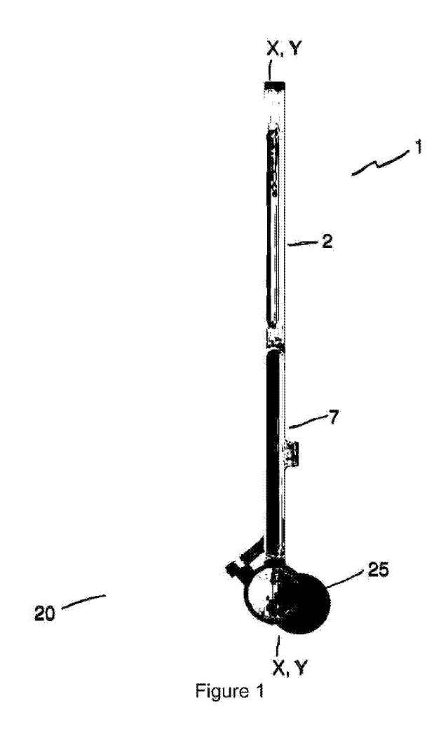

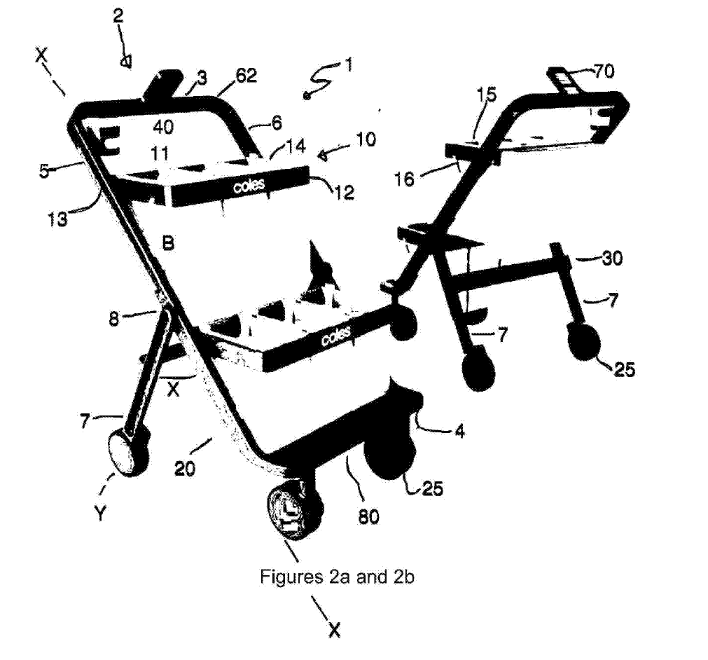

In the accompanying drawings there is disclosed a foldable trolley 1 having an elongate frame 2 defining a frame axis XX. The frame 2 at point 8 having a first end 3, a second end 4 and sides 5 and 6 extending therebetween. An elongate arm 7 defines an arm axis YY. The arm 7 is pivotally attachable to the frame 2 and adapted in use to move from a stored position (see FIG. 1) where the arm axis YY is substantially parallel to the frame axis XX and a use position (see FIGS. 2a to 2b) where the arm axis YY is substantially perpendicular to the frame axis XX. The angle a between axes XX and YY can vary depending upon the desired use of the trolley 1. There could be a lock (not shown) to set the angle α. The trolley 1 further includes a support member 10 having a first end 11, a second end 12 and sides 13 and 14 extending therebetween. The support member 10 being pivotally attachable to the frame 2 and adapted in use to move from a stored position (see FIG. 1) where said member 10 is substantially parallel to said frame axis XX and a use position (see FIGS. 2a to 2b) where support member 10 is locatable at an acute angle β to the frame axis XX. The pivoting can be a single pivot at point 15 or include an arm or other pivot or hinge mechanism 16 additionally.

The support member 10, as best seen in the drawings, is adapted in use to hold bags 20 or the like in the use position. In the preferred form, they would be “green” bags.

In a preferred form, the trolley 10 includes two arms 7 being connected at one end to the sides 5, 6 of the frame 2 and at said other end to one or more wheels 25 to permit the trolley 1 to move along a surface. The two arms 7 (as best seen in FIG. 2b) are connected by one or more connecting members 30. The frame 2 includes at least one wheel 25 at one said end 4. The wheels 25 can include guards, axels, covers and the like (not shown).

Preferably, the frame 2 is generally a rectangular ring shape as shown in the drawings however could be any shape. The ends 3, 4 and sides 5, 6 defining a space 40 therebetween.

In a preferred form, the support members 10 sit within the space 40. The support members 10 are also preferably rectangular ring-shaped and define an aperture 50 therebetween to receive the bags 20. In the Figures, three green bags 20 are shown within the aperture 50. However, any number of bags 20 could be accommodated.

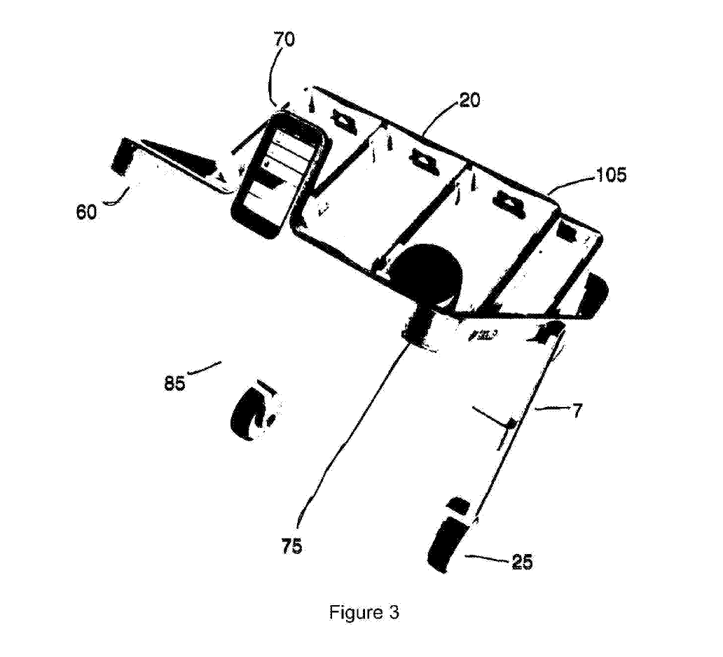

In one preferred form, and as best seen in FIG. 3, the present invention includes a handle 60 including grooves 62, a phone holder 70 and a beverage holder 75.

The trolley 1 could further include a foot platform 80 or the like which children could stand on. The present invention could also include a brake (not shown), a locating means such as a GPS tracker (not shown) and a music playing device (not shown).

Advantageously, the present invention at least in a preferred embodiment, provides common components to reduce costs and could also include a single moulded product. It can include spacing for branding or the like, can include large 150 mm fixed wheels 25, can easily hold at least 6 shopping bags 20 on two or more levels within the frame 2 and could also include a rear bag 85 for personal belongings or the like. The “green” bags 20 could be attached by way of hooks 105 or the like.

Advantageously, the phone holder 70 and cup holders 75 could be rotatable or movable about the frame 2 (such as by snap locking engagement) to assist a user. The trolley 1 could also include a child-seat (not shown) or connectors (not shown) to connect two or more trolleys 1 together.

The invention in preferred embodiments can be folded into a boot of a car and prevents clutter and delay in car parks. With rising city apartment living can be used to buy groceries at increasing number of smaller supermarkets and taken to an apartment by foot. It is more hygienic, prevents transferable/communicable diseases arising from thousands of people using the same trolley. Eliminates an eyesore of dumped trolleys, reduces environmental damage by removing plastic bags from oceans/landfill etc.

Although the invention has been described with reference to specific examples, it will be appreciated by those skilled in the art that the invention may be embodied in many other forms.

1. A foldable trolley, said trolley having:
an elongate frame defining a frame axis and having a first end, a second end and sides extending therebetween;
an elongate arm defining an arm axis, said arm pivotally attachable to said frame and adapted in use to move from a stored position, where said arm axis is substantially parallel to said frame axis, and a use position, where said arm axis is substantially perpendicular to said frame axis; and
a support member having a first end, a second end and sides extending therebetween, said support member pivotally attachable to said frame and adapted in use to move from a stored position, where said member is substantially parallel to said frame axis and a use position, where said support member is locatable at an acute angle to said frame axis;
said support member adapted in use to hold bags in said use position.

2. The foldable trolley according to claim 1, wherein said trolley includes two arms, said arms being connected at one end to said sides of said frame and at said other end to one or more wheels to permit said trolley to move along a surface.

3. The foldable trolley according to claim 1, wherein said two arms are connected by a connecting member.

4. The foldable trolley according to claim 1, wherein said frame includes at least one wheel at one said end.

5. The foldable trolley according to claim 1, wherein said frame is generally a rectangular ring shape, the ends and sides defining a space therebetween.

6. The foldable trolley according to claim 1, wherein said support members are locatable and pivotable within said space.

7. The foldable trolley according to claim 1, wherein said support members are a rectangular ring shape and define an aperture therebetween.

8. The foldable trolley according to claim 1, wherein in use said bags are locatable within said aperture.

9. The foldable trolley according to claim 1, wherein an end of said frame includes a handle.

10. The foldable trolley according to claim 1, wherein an end of said frame includes a foot platform.

11. The foldable trolley according to claim 1, wherein said frame includes two or more support members adapted to hold bags in use within said space.

12. The foldable trolley according to claim 1, wherein said support members are positionable between said sides of said frame.
